(19) United States
(12) Patent Application Publication
(10) Pub. No.: US 2010/0110964 A1
(43) Pub. Date: May 6, 2010

(54) Method for Relays within Wireless Communication Systems

(75) Inventors: Robert T. Love, Barrington, IL (US); Ajit Nimbalker, Arlington Heights, IL (US); Kenneth A. Stewart, Grayslake, IL (US); Xiangyang Zhuang, Lake Zurich, IL (US)

Correspondence Address: MOTOROLA INC, 600 NORTH US HIGHWAY 45, W4 - 39Q, LIBERTYVILLE, IL, 60048-5343, US

(73) Assignee: Motorola, Inc., Schaumburg, IL (US)

(21) Appl. No.: 12/610,962

(22) Filed: Nov. 2, 2009

Related U.S. Application Data
(60) Provisional application No. 61/111,321, filed on Nov. 4, 2008.

(51) Int. Cl. H04J 3/06; H04B 7/14; H04H 20/71

(52) U.S. Cl. 370/312; 370/315; 370/350

(57) ABSTRACT

A relay design backward compatible with existing wireless communication networks. The invention provides details of apparatus and methods to enable operation of inband relays. Using a grant-based inhibit mechanism, a Relay and an eNB can efficiently cooperate to improve the performance by allowing one of either UE or the Relay to transmit on the uplink. Similarly, the UE overrides any pre-determined schedule (i.e., absence of Reference Signals) by searching for a scheduling grant and if the UE find the scheduling grant, the UE can assume that the Relay has overridden the pre-determined schedule temporarily.

### CROSS REFERENCE TO RELATED APPLICATIONS

The present application is related to co-pending U.S. Application No. 61/111,321 filed on 4 Nov. 2008, the contents of which are hereby incorporated by reference and from which benefits are claimed under 35 U.S.C. 119.

### FIELD OF THE DISCLOSURE

The present disclosure relates generally to multi-hop wireless communication systems and, more particularly, to a method for relaying within multi-hop wireless communication systems.

### BACKGROUND

In wireless communications networks, for example, in the developing 3GPP LTE-Advanced network protocol there is a need to develop solutions that can provide better user experience while reducing the infrastructure cost. Deployment of Relay nodes is one such method wherein the base station (eNB) communicates with a User Equipment (UE) with the help of an intermediate relay node (RN), for example, when the distance between eNB and UE exceeds the radio transmission range of the nodes or when a physical barrier is present between the eNB and UE to degrade the channel quality. Generally, more than one Relay nodes can forward data from the eNB to the UE. In such situations, each intermediate node routes the packets (e.g., data and control information) to the next node along the route, until the packets reach their final destination.

Networks implementing single hop links between an eNB and a UE can severely stress link budgets at the cell boundaries and often render the users at the cell edge incapable of communicating using the high data rates. Pockets of poor-coverage areas or coverage holes are created where communication becomes increasingly difficult. This in turn reduces overall system capacity as well user service satisfaction. While such coverage voids can be avoided by deploying eNBs tightly, this significantly increases both the capital expenditure (CAPEX) and operational expenditure (OPEX) for network deployment. A cheaper solution is to deploy relay nodes (also known as relays or repeaters) in areas with poor coverage and repeat transmissions to better server subscribers in these areas.

Even with the deployment of relay stations within a network, there remain some mechanisms that can further reduce costs. Typically, the traffic in the UE that the RN serves is routed through the eNB to the Relay link, which acts as the backhaul link. The relay shares the same resources (frequency, time, spatial, spreading codes, etc) with other UEs served by the eNB. At the same time, the relay is expected to act as an infrastructure entity to serve another set of users (hereinafter referred to as UE2).

There are practical limitations on simultaneous transmit and receive devices that are dictated by the physics of electrical circuit design. If a relay transmits and receives at the same time on the same (or adjacent) frequency resources, significant interference (or desensing) is expected to cause performance degradations. This issue is typically resolved by providing large spatial separation between transmit and receive hardware in the relay device, but this solution is typically undesirable. Another way of reducing desensing is by using advanced interference cancellation hardware, but this negates the cost benefits of relays. One other way of resolving this problem is by providing enough separation in frequency or time between the transmit and receive chains. Typically, with sufficient frequency separation that avoids desensing, relay operation becomes an out-of-band operation where the transmit and receive chains do not interfere with each other. With time separation, the relay is limited to performing either the transmit or receive operation at a time, and a sufficient guard interval may be provided when necessary to enable the relay to switch from transmit to receive.

The various aspects, features and advantages of the disclosure will become more fully apparent to those having ordinary skill in the art upon a careful consideration of the following Detailed Description thereof with the accompanying drawings described below. The drawings may have been simplified for clarity and are not necessarily drawn to scale.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 illustrates a wireless communication system.

FIG. 2 is illustrates an inband relay communication.

FIG. 3 illustrates two examples where relay and a UE simultaneously communicate with a macro-eNB and a relay on the uplink in the same subframe.

FIG. 4 illustrates a timing diagram for operating an inband relay in a wireless communication system.

FIG. 5 illustrates the UL HARQ processes of a UE2 that clashes with relay to Macro eNB UL transmissions.

FIG. 6 illustrates transmitting in an UL control resource in a group of sub-frames configured according to a predetermined schedule; receiving a DL control transmission; detecting a indicator message allocated to the wireless communication entity, the indicator message is in the DL control transmission; temporarily modifying the transmission on the UL control resource based on the indicator message contrary to the predetermined schedule.

FIG. 7 illustrates receiving a DL control transmission indicating that a sub-frame in a group of sub-frames is blank; decoding a control resource of the blank sub-frame for control information; detecting a scheduling message in the control resource of the blank sub-frame

FIG. 8 illustrates receiving a DL control transmission indicating that a sub-frame in a group of sub-frames is blank; decoding a control resource of a DL sub-frame, other than the blank sub-frame, for a configuration message about the blank sub-frame; detecting the configuration message about the blank sub-frame.

FIG. 9 is flowchart that shows transmitting in an UL control resource in a group of sub-frames configured according to a predetermined schedule; receiving a DL control transmission; detecting a indicator grant allocated to the wireless communication entity, the indicator message is in the DL control transmission; temporarily modifying the transmission on the UL control resource based on the indicator message contrary to the predetermined schedule.

FIG. 10 is a flowchart that shows receiving a DL control transmission indicating that a sub-frame in a group of sub-frames is blank; decoding a control resource of the blank sub-frame for control information; detecting a scheduling message in the control resource of the blank sub-frame.

FIG. 11 is a flowchart that shows receiving a DL control transmission indicating that a sub-frame in a group of sub-frames is blank; decoding a control resource of a DL sub-frame, other than the blank sub-frame, for a configuration message about the blank sub-frame; detecting the configuration message about the blank sub-frame.

FIG. 12 illustrates a timing diagram showing the Macro-eNB and relay where UE2 to Relay uplink is disabled.

FIG. 13 illustrates a timing diagram showing the Macro-eNB and Relay where Relay to Macro-eNB uplink is disabled.

FIG. 14 is illustration of an appartus in a wireless communication entity that processes the inhibit grant that modifies UL transmissions.

FIG. 15 is illustration of an appartus in a wireless communication entity wherein the UE decodes a blank subframe and determines whether the sub-frame is indeed blank or not.

FIG. 16 i is illustration of an appartus in a wireless communication entity wherein the UE decodes a subframe other than a blank sub-frame and determines whether the blank sub-frame is indeed blank or not.

FIG. 17 illustrates a possible configuration of a computing system to act as a base station.

### DETAILED DESCRIPTION

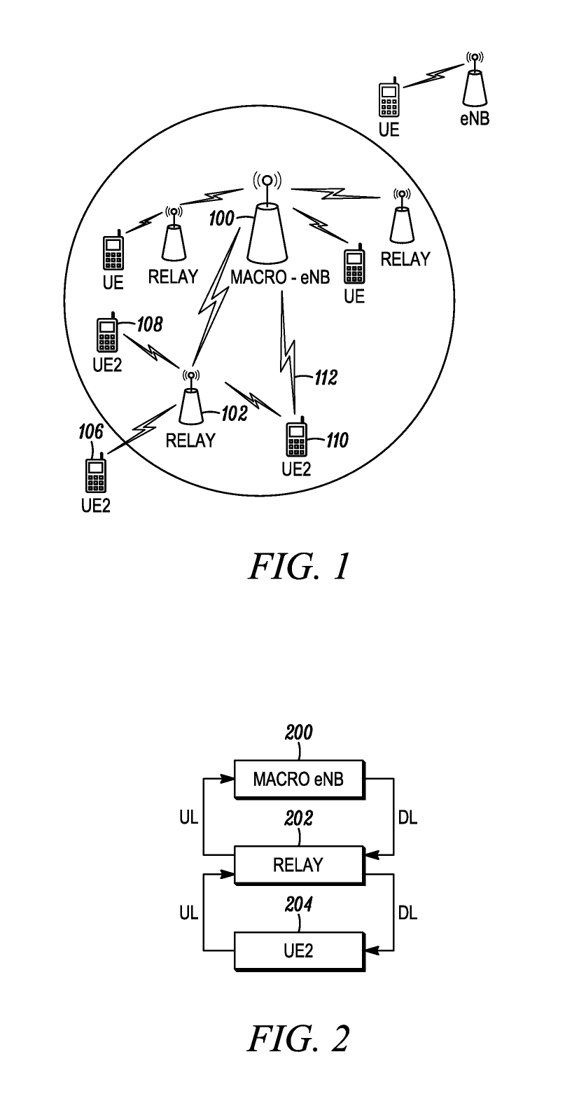

In FIG. 1, a wireless communication system comprises one or more fixed base infrastructure units forming a network distributed over a geographical region. The base unit may also be referred to as an access point, access terminal, base, base station, Node-B, eNode-B, eNB, Home Node-B, relay node, or by other terminology used in the art. In FIG. 1, the one or more base units 100, serve a number of remote units 110 within a serving area, for example, a cell or a cell sector via a wireless communication link 112. The remote units may be fixed units or mobile terminals. The remote units may also be referred to as subscriber units, mobiles, mobile stations, users, terminals, subscriber stations, user equipment (UE), terminals, relays, or by other terminology used in the art.

In FIG. 1, generally, the base units 100 transmit downlink communication signals to serve remote units in the time and/or frequency domain. The remote units 110 and 102 communicate with the one or more base units via uplink communication signals. The remote units 106 and 108 communicate with the base unit via the relay 102. The one or more base units may comprise one or more transmitters and one or more receivers for downlink and uplink transmissions. The remote units may also comprise one or more transmitters and one or more receivers. The base units are generally part of a radio access network that includes one or more controllers communicably coupled to one or more corresponding base units. The access network is generally communicably coupled to one or more core networks, which may be coupled to other networks, like the Internet and public switched telephone networks, among others. These and other elements of the access and core networks are not illustrated but they are known by those having ordinary skill in the art.

FIG. 17 illustrates a possible configuration of a computing system to act as a base station 100. The base station may include a controller/processor 1710, a memory 1720, a database interface 1730, a transceiver 1740, input/output (I/O) device interface 1750, and a network interface 1760, connected through bus 1770. The base station may implement any operating system, such as Microsoft Windows®, UNIX, or LINUX, for example. Client and server software may be written in any programming language, such as C, C++, Java or Visual Basic, for example. The server software may run on an application framework, such as, for example, a Java® server or .NET® framework.

The controller/processor 1710 may be any programmed processor known to one of skill in the art. However, the decision support method may also be implemented on a general-purpose or a special purpose computer, a programmed microprocessor or microcontroller, peripheral integrated circuit elements, an application-specific integrated circuit or other integrated circuits, hardware/electronic logic circuits, such as a discrete element circuit, a programmable logic device, such as a programmable logic array, field programmable gate-array, or the like. In general, any device or devices capable of implementing the decision support method as described herein may be used to implement the decision support system functions of this invention.

The memory 1720 may include volatile and nonvolatile data storage including one or more electrical, magnetic or optical memories such as a random access memory (RAM), cache, hard drive, or other memory device. The memory may have a cache to speed access to specific data. The memory 1720 may also be connected to a compact disc-read only memory (CD-ROM), digital video disc-read only memory (DVD-ROM), DVD read write input, tape drive, or other removable memory device that allows media content to be directly uploaded into the system. Data may be stored in the memory or in a separate database. The database interface 1730 may be used by the controller/processor 1710 to access the database. The database may contain any formatting data to connect the UE 110 to the network.

The transceiver 1740 may create a data connection with the UE 110. The transceiver may create a physical downlink control channel (PDCCH) and a physical uplink control channel (PUCCH) between the base station 100 and the UE 110.

The I/O device interface 1750 may be connected to one or more input devices that may include a keyboard, mouse, pen-operated touch screen or monitor, voice-recognition device, or any other device that accepts input. The I/O device interface 1750 may also be connected to one or more output devices, such as a monitor, printer, disk drive, speakers, or any other device provided to output data. The I/O device interface 1750 may receive a data task or connection criteria from a network administrator.

The network connection interface 1760 may be connected to a communication device, modem, network interface card, a transceiver, or any other device capable of transmitting and receiving signals from the network. The network connection interface 1760 may be used to connect a client device to a network. The network connection interface 1760 may be used to connect the teleconference device to the network connecting the user to other users in the teleconference. The components of the base station 100 may be connected via an electrical bus 1770, for example, or linked wirelessly.

Client software and databases may be accessed by the controller/processor 1710 from memory 1720, and may include, for example, database applications, word processing applications, as well as components that embody the decision support functionality of the present invention. The base station 100 may implement any operating system, such as Microsoft Windows®, LINUX, or UNIX, for example. Client and server software may be written in any programming language, such as C, C++, Java or Visual Basic, for example. Although not required, the invention is described, at least in part, in the general context of computer-executable instructions, such as program modules, being executed by the electronic device, such as a general purpose computer. Generally, program modules include routine programs, objects, components, data structures, etc. that perform particular tasks or implement particular abstract data types. Moreover, those skilled in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like.

In one implementation, the wireless communication system is compliant with the developing Long Term Evolution (LTE) of the 3GPP Universal Mobile Telecommunications System (UMTS) protocol, also referred to as EUTRA or Release-8 (Rel-8) 3GPP LTE, wherein the base station transmits using an orthogonal frequency division multiplexing (OFDM) modulation scheme on the downlink and the user terminals transmit on the uplink using a single carrier frequency division multiple access (SC-FDMA) scheme. More generally, however, the wireless communication system may implement some other open or proprietary communication protocol, for example, WiMAX, among other protocols. The present disclosure is not intended to be limited to the implementation of any particular wireless communication system architecture or protocol. In another implementation, the wireless communication system may be compliant with the developing Long Term Evolution (LTE)—Advanced of the 3GPP Universal Mobile Telecommunications System (UMTS) protocol, also referred to as LTE-Advanced.

Typically, it is desirable to have backwards compatibility to serve UEs that are compliant with the EUTRA or the Rel-8 3GPP LTE specification. Generally, the introduction of the Relays improves the performance (or level of service) to a Rel-8 UE. Even with the deployment of relay stations within a network, there remain some mechanisms that can further reduce costs. Typically, the traffic in the UE that the Relay node is routed through the eNB to the Relay link, which acts as the backhaul link. FIG. 2 shows an example. The relay 202 shares the same downlink (DL) and uplink (UL) resources (frequency, time, spatial, spreading codes, etc) as a typical UE that is being served by the Macro eNB 200. At the same time, the relay is expected to act as an infrastructure entity to serve another UE 204 (hereafter referred to as UE2).

In a Frequency Division Duplex (FDD) operation, the frame structure in the uplink and downlink comprises of a 10 millisecond (ms) Radio frame, which is in turn divided into ten subframes, each of 1 ms duration, wherein each subframe is divided into two slots of 0.5 ms each, wherein each slot contains a number of OFDM symbols. The downlink and uplink bandwidth are subdivided into resource blocks, wherein each resource block comprises of one or more subcarriers. A resource block (RB) is typical unit in which the resource allocations are assigned for the uplink and downlink communications. Furthermore, the eNB configures appropriate channels for uplink and downlink control information exchange.

Following are some assumptions that a Rel-8 FDD UE makes with regard to frame structure. Subframes #0, #4, #5 in a Radio Frame are “normal” subframes and all Common Reference Symbols (CRS) or pilot symbols are available in these subframes for UE measurements and other purposes. The remaining subframes in the radio frame maybe characterized as “normal” or “Multicast Broadcast Single Frequency Network (MBSFN)” subframes. In a “normal” subframe, the UE can use all CRS to aid measurements or channel estimation algorithms. In an “MBSFN” sub-frame, the UE can use the CRS in the 1 st and 2 nd OFDM symbols only to aid measurement. For an MBSFN pattern that is periodic with period 10 ms, the six patterns of subframes that can be characterized as MBSFN are {#1}, {#1,#2}, {#1,#2,#3}, {#1,#2,#3,#6}, {#1,#2,#3,#6,#7}, {#1,#2,#3,#6,#7,#8}. The MBSFN configuration in a radio frame is signaling by a System Information Broadcast (SIB) message. It is possible to have a simple bit map to label each of the six remaining subframes as a MBSFN subframe or a normal subframe.

The above suggests that a relay cell should have its own Physical Cell-ID (or PCID) to be detected and measured by Rel-8 UEs and the relay cell will have to always transmit all CRS in four subframes (#0,#4,#5, #9) in each radio frame. Of the remaining 6 subframes in a radio frame, the relay cell always transmits the CRS in at least the 1 st and 2 nd OFDM in each MBSFN subframe and always transmits all CRS in each normal subframe.

The above also suggests that if a Relay wishes to receive Physical Dowlink Shared Channel (PDSCH) from a Macro-eNB, the relay has to inform the UEs in the relay cell that there are MBSFN subframes with one of the following patterns—{#1}, {#1,#2}, {#1,#2,#3}, {#1,#2,#3,#6}, {#1,#2,#2,#3,#6,#7}, {#1,#2,#3,#6,#7,#8}. Thus, there may be a requirement that a relay receives from a Macro-eNB in contiguous subframes. If a simple bit map to label each of the six remaining subframes as a MBSFN subframe or a normal subframe is possible, then it allows more flexibility in the design.

Given the desirability for backwards compatibility, the following is a way of operating the inband Relay operation. A capability negotiation between a macro-eNB and a Relay, wherein the eNB-Relay communication is agreed in certain time-frequency-space resources. The relay offsets the subframe #0 in the Relay cell by an RELAY_SUBFRAME_OFFSET relative to the macro-eNB subframe #0. The macro-eNB can assign persistent resources in certain subframes for Macro eNB-Relay communication (with some guard period for the relay to switch from transmit to receive), examples include a slot-level resource assignment, etc. This region may be assigned on a semi-persistent basis for a group of relays.

The macro-eNB may assign persistent resources in certain subframes for relay-macro eNB communication (that could be tied to the macro eNB—relay DL) with guard periods to allow the relay to switch from transmit to receive. Note that no guard period may be required when the relay is transmitting on consecutive uplink subframes to the macro eNB or it is receiving from the UE2 on two consecutive subframes.

The macro-eNB to relay communication may be asynchronous adaptive in both UL and DL. The relay assigns resources in certain subframes for UE2-relay communication whenever the relay-macro eNB communication is not scheduled or is deactivated. This is valuable because the Macro eNB and relay cooperate on a more dynamic basis to make efficient use of resources. It may be preferable for a relay to activate only a subset of UL HARQ processes for the UEs in the relay cells. This subset of UL HARQ process comprises of HARQ processes corresponding to TTIs where there is no collision between Relay-Macro eNB and UE2-relay uplink communication. HARQ processes with no collisions may be used to serve higher priority traffic. This subset also comprises of HARQ processes corresponding to TTIs where there may be collisions between relay-macro eNB and UE2-relay uplinks with a collision-avoidance or collision-handling mechanism. HARQ processes that may occasionally encounter collisions may be used to serve lower priority traffic (with flexible delays).

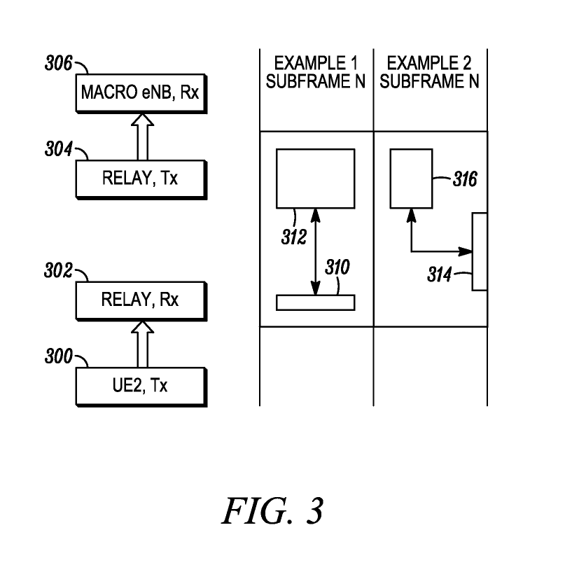

There is certain uplink control information that a relay can schedule UE2 to transmit on the uplink when the relay itself is communicating with the macro-eNB on the uplink. Examples include sounding, Channel Quality Information, etc. In these cases, there may be additional guard or switching period available for the relay to process UE2 control information. FIG. 3 shows two examples in which a UE2 transmission 300 to relay reception 302 on the uplink, and a concurrent relay transmission 304 to macro eNB reception 306 on the uplink in the same sub-frame takes place. In the first example, the two simultaneous transmissions—UE2 transmission 310 and relay transmission 312 in the frequency domain are well-separated in frequency (shown by double-arrowed line) to minimize interference. Similarly, in the second example, the two simultaneous transmissions—UE2 transmission 314 and relay transmission 316 are separated in time domain via guard interval (shown by double-arrowed line) to minimize interference.

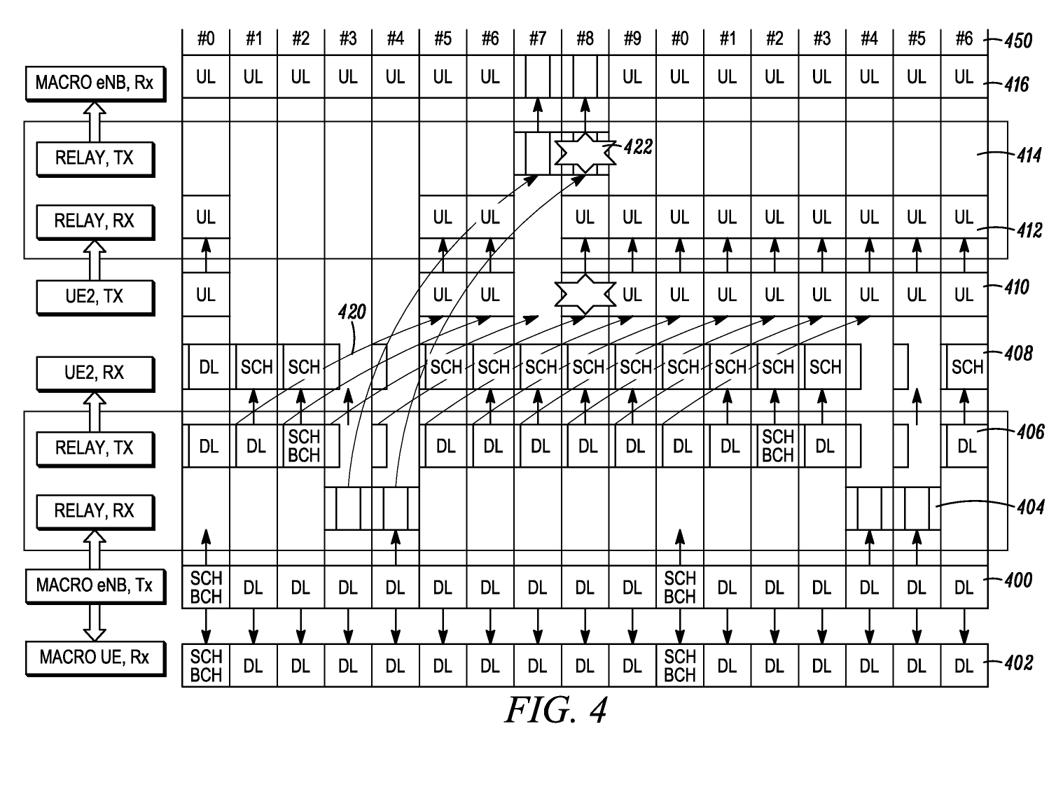

An example of a relay frame structure is shown in FIG. 4 wherein all subframe numbering is with respect to the macro-eNB radio frame (for convenience). Relay subframes are offset by a value Relay_SubFrame_Offset relative to the Macro eNB_SubFrame. In the example, this value is 2 i.e., Macro eNB is transmitting Physical Broadcast Channel (PBCH) in sub-frame #0, Synchronization channels in #0 and #5. The relay cell transmits the Relay Cell—PBCH in #2, Relay Cell Synchronization channels in #2 and #7.

The relay and macro-eNB negotiate radio resource capabilities (via a special SIB or initial setup) and agree that relay will receive radio resources from the macro eNB in subframes #4,#5 (if bitmap MBSFN is allowed) in each radio frame and correspondingly relay will transmit on the uplink to macro-eNB N_Relay_eNB_Delay subframes later for each received DL subframe. The relay will designate subframes #4,#5 as MBSFN subframes. All subframe number is with regard to Macro eNB.

The rely receiving in DL subframe number 10*n_RF+a, shall transmit in UL subframe 10*n_RF+a+b, where a and b are based on configuration information. Typically, when rlay is serving Rel-8 UEs, there is an advantage of using b=4, although in general, the macro-eNB and relay can configure the value of b, dynamically or semi-statically. b=4 advantageous because when a relay is receiving from eNB in subframe number 10*n_RF+a, the relay is transmitting no Physical Downlink Shared Channel (PDSCH) to the Rel-8 UEs in (10*n_RF+a) and therefore the relay does not expect any ACK/NACK from the Rel-8 UEs four subframes later i.e., (10*n_RF+a+4).

For Rel-8 UE2 that is being served by the Relay, since the UL HARQ is synchronous, UE2 expects that every 8 ms it has a retransmission opportunity. However from previous bullet, we note that the Relay→Macro-eNB uplink communication is scheduled in every (10*n_RF+a+b) subframe. Thus there is a need to avoid collisions wherein UE2 may be unable to use HARQ processes labeled as (10*n_RF+a+b) mod 8.

In the example, if a={3,4} and b={4}, then all HARQ processes for UE2 to Relay UL will experience collisions with relay to eNB UL. The following Tables show an example wherein the first set of highlighted columns shows the TTIs in which the macro eNB to relay DL communication takes places and the second set of highlighted columns show the corresponding UL HARQ processes in UE2→relay UL that collides with the relay→macro eNB UL. Thus UE2 experience collisions on all UL HARQ processes. FIG. 4 shows a complete frame structure for relay operation using MBSFN Signaling. The timing diagram assumes sub-frame numbering 450 with respect to the macro-eNB radio frame boundary. The Macro-eNB transmits on its downlink 400 to UE that receives the downlink information 402 from the macro-eNB. The relay receives from the macro-eNB on the downlink 404 in some of the subframes. The relay transmits on its downlink to UE2 that receives the downlink information 408 from the relay. Whenever the relay is receiving information from Macro eNB, it configures the corresponding subframes in the relay to UE2 link as MBSFN subframes 420. In LTE FDD, the UE follows the downlink control information receives on sub-frame n to determine the un-configured uplink transmissions on subframe n+4. The UE2 transmits on its uplink 410 to relay that receives the downlink information 412 from the UE2. The relay transmits on the uplink 414 to the macro-eNB 416 in some of the subframes. Whenever the relay is transmitting information to Macro eNB, it has to ensure that the corresponding subframes in the Relay to UE2 link as are blanked. If such subframes are not blanked, then collisions 422 occur in the uplink. Collisions can lead to degraded performance and link losses.

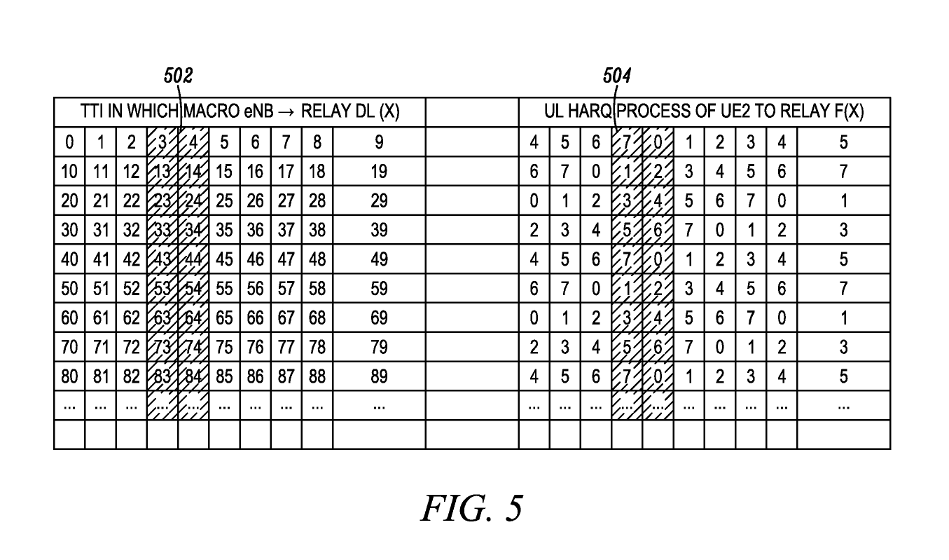

In another example, if a={3} and b={4}, then all even number HARQ processes for UE2 will experience collisions while odd numbered HARQ processes do not have any collisions. This can be seen in FIG. 5 wherein the first highlighted column of first set of highlighted columns shows the TTIs in which the macro eNB to Relay DL communication takes places and the first highlighted column of second set of highlighted columns show the corresponding UL HARQ processes in UE2→relay UL that collides with the relay→macro eNB UL. For example, a macro eNB to relay DL communication in subframe 3 502 will lead to an uplink transmission from the relay to macro-eNB in subframe 7, which corresponds to HARQ process number 7 504 on the UE2 to relay uplink. Therefore, there is a collision on the uplink. The collision can be avoided by either the relay or macro-eNB deferring the transmission. A

The above example shows that with a proper negotiation of resources with macro eNB, a relay may be able to simplify the scheduling processes for the UEs under its control. In the above example, for lightly loaded cells, the following is a favorable set selection: Relay_SubFrame_Offset=even (e.g., 2), a={0,2,4,6,8}, b=4. The UE2 can operate on HARQ processes 0,2,4,6 without experiencing any collisions. It is possible to assign HARQ processes {1,3,5,7,} for traffic that can tolerate extra delays. If two consecutive subframes are used for macro-eNB to relay downlink, then in a 40 ms window, each HARQ process gets blocked twice, i.e., a packet occurring on HARQ process will get only 3 transmission opportunities instead of 5 due to collision avoidance.

A relay may not transmit to UE2 while receiving from macro eNB. A relay may not receive from UE2 while transmitting to macro eNB.

A Relay can inhibit or disable UE2 uplink transmissions in subframe n with a special grant transmitted in subframe n−4 control region. In 3GPP LTE systems, this timing relationship can be different if UE2 is a Rel-10 device or for a Rel-8 TDD device. If UE2 is inhibited on subframe n then it would not e.g., transmit on its uplink control resource or Physical Uplink Control CHannel (PUCCH) and also on physical uplink data channel (PUSCH) on subframe n. Thus, the relay can essentially blank out a subframe on the uplink from UE2 so that the relay can communicate with the macro-eNB on the uplink. Presumably UE2 would, when appropriate, also receive an ACK on its Physical Harq Indication Channel (PHICH) on subframe n−4 control region to disable any non-adaptive PUSCH retransmissions thereby precluding any UE2→Relay transmissions which the relay cannot decode anyway while it is transmitting to the Macro eNB.

Typically, to reduce control overhead, an eNB configures the UL control resources according to pre-determined schedule. However, the pre-determined schedule can lead to collisions in a relay system wherein the relay might be transmitting data on the UL to the macro-eNB and the UE2 may be transmitting UL control to the relay according to pre-determined schedule. Therefore, there is a need to override the pre-determined scheduler or higher-layer signaling temporarily. One method is as follows: transmit in an UL control resource in a group of sub-frames configured according to a predetermined schedule; receive a DL control transmission; detect an indicator message allocated to the wireless communication entity, the indicator message is in the DL control transmission; temporarily modify the transmission on the UL control resource based on the indicator message contrary to the predetermined schedule. In some embodiments, the indicator message may be a scheduling message or a scheduling grant.

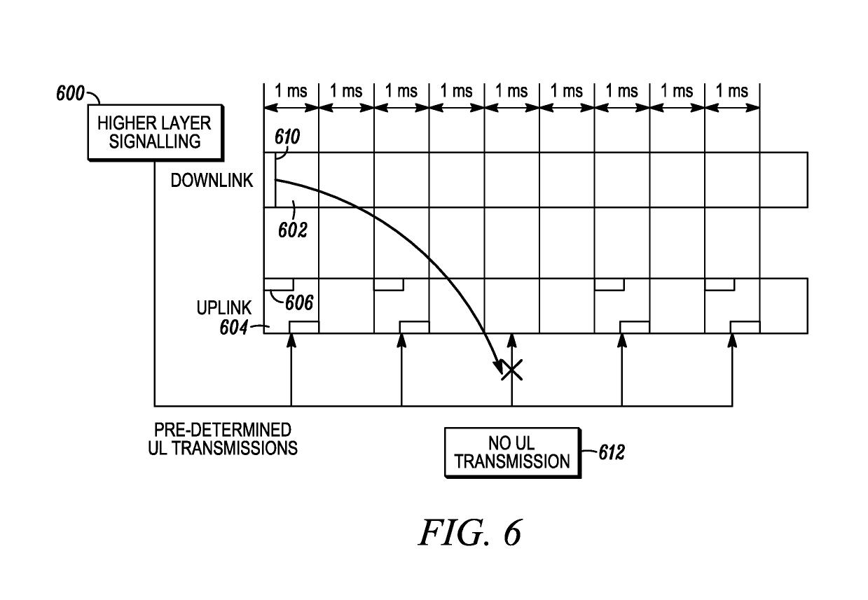

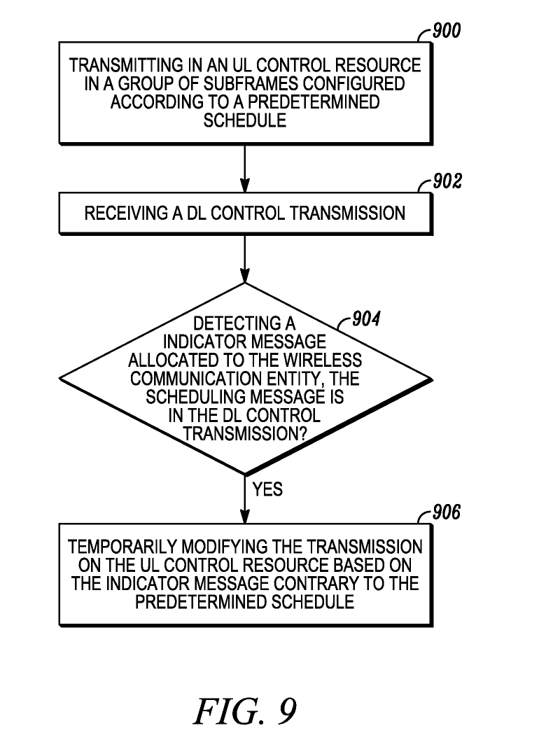

FIG. 6 shows an illustration wherein higher layer signaling 600 configures the transmission in an UL control resource in a group of sub-frames configured according to a predetermined schedule. The UE receives in DL sub-frames 602 and transmits in UL sub-frames 604. The UE receives a DL control transmission and detects a indicator message 610 allocated to itself and then the UE temporarily modifies the transmission 610 on the UL control resource based on the indicator message contrary to the predetermined schedule. FIG. 9 shows a flowchart.

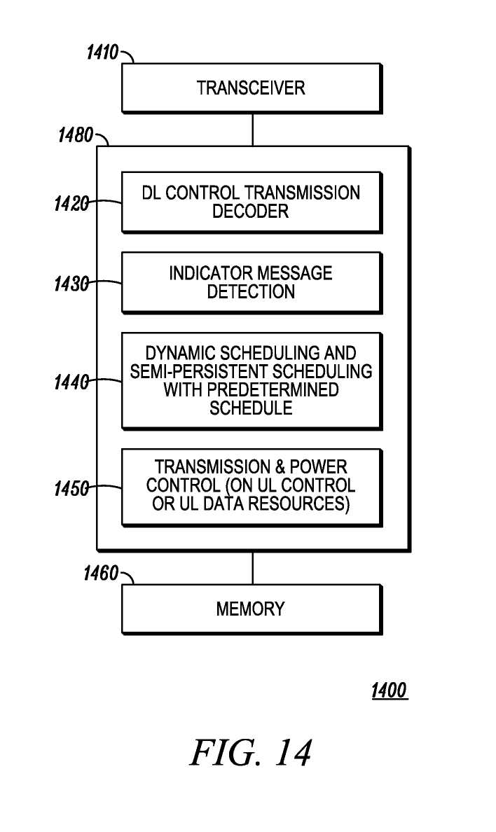

FIG. 14 shows a possible implementation with a memory 1460, a controller 1480 coupled to the transceiver 1410, the controller configured to cause the transceiver to transmit in an UL control resource in a group of sub-frames configured according to a predetermined schedule, the controller configured to detect a scheduling grant, in a downlink control transmission, allocated to the wireless communication entity via a DL control Transmission decoder 1420; the controller configured to temporarily modify the transmission in the UL control resource such as Dynamic Scheduling and Semi-Persistent Scheduling with pre-determined schedule 1440 and or Transmission and Power control on UL control or UL data resources 1450 based on the indicator message contrary to the predetermined schedule.

In one implementation, the method of temporarily modifying the transmission includes not transmitting in the UL control resource in at least one sub-frame configured according to a predetermined schedule.

According to another embodiment the method of temporarily modifying the transmission includes not transmitting in at least one UL sub-frame configured according to a predetermined schedule.

According to another embodiment, the method of temporarily modifying the transmission includes disabling transmission in the UL control resource in at least one sub-frame configured according to a predetermined schedule.

According to another embodiment the method of temporarily modifying the transmission includes disabling transmission in at least one UL sub-frame configured according to a predetermined schedule.

According to another embodiment, the method of detecting the indicator message uses a CRC scrambling mask.

According to another embodiment, the method of detecting the indicator message is by detecting a physical downlink control channel (PDCCH) which includes the scheduling grant and a CRC that is scrambled with a mask determined by a radio network temporary identifier (RNTI)

According to another embodiment, the method of detecting the indicator message is by detecting a physical downlink control channel (PDCCH) which includes the scheduling message and a CRC that is scrambled with a mask determined by a Relay RNTI.

According to another embodiment, the method of detecting the indicator message is by detecting a physical downlink control channel (PDCCH) which includes the scheduling message via indicator message payload scrambling.

According to another embodiment, the DL control transmission is a broadcast control transmission.

According to another embodiment, the indicator message is determined based upon a specific field that constitutes the scheduling message.

When there is no need for a relay→macro eNB transmission on subframe n then the relay would not disable UE2 transmissions on subframe n. That is, it would not transmit an “inhibit” grant on subframe n−4. Hence, the resources in subframe n would not become idle (unused) unless both the UE2 and Relay had no scheduled transmissions or retransmissions and the UE2 had no PUCCH or PUSCH report to send. For a full service Relay that we are considering, the relay would not be able to receive Macro-eNB DL transmissions in the Macro-eNB's Rel-8 control region of subframe n−4 (because the Relay is transmitting its own control region to UE2 during this duration). If consecutive Macro eNB→Relay subframe transmissions in subframes n−4 and n−3 the Macro eNB→Relay control region could be restricted to occur only in subframe n−4. In that case, either the inhibition grant would indicate the UE2 would be inhibited from transmitting on both subframes n and n+1 or bits in the grant could indicate whether it was inhibited on subframe n or n+1 or both.

An inhibit grant could use the current DCI format 1C payload size which has 16-bit CRC, 3-10 bit resource allocation field (its size varies with system bandwidth) and a 5-bit MCS field. The fields could be redefined to provide inhibit indication information and/or other relay information. Note that LTE Rel-10 could define an altogether new inhibition/compact UL grant but it is best to minimize the number payload sizes to avoid more blind detections. That is, it is better to redefine fields in pre-existing payload sizes when creating new DCI formats. Another 16-bit RNTI value could be defined (e.g. as RN-RNTI) to indicate when this grant (a new grant format 1E) is present in the control region. Reliability will be good since 8 CCEs can be used (for BW>1.4 MHz) and there will not be any other use for control region CCEs in subframe n−4. Alternatively, the inhibition may be indicated as a CRC mask for a PDCCH grant associated with a specially designed UE-specific RNTI or non-UE specific RNTI or a CSG-specific RNTI. Typically, in the Relay cell, subframe n−4 may be an MBSFN subframe and hence there is very high chance of having 8 CCEs to be assigned for this special grant. To have 8 CCEs requires the downlink control region size is 2 symbols for 5 MHz. For 10 MHz or greater than a control region size of 1 OFDM symbol is enough for 8 CCEs. Alternatively, the unused PCFICH state could be used as the inhibit indication with the assumption that the control region size is j symbols where j is signaled by higher layers.

Given that the relay cannot transmit the inhibit grant or indication in the same control region and subframe n−4 that it receives an inhibit indication (i.e. presence or absence of scheduling grant (or PCFICH unused state based inhibit indictation) from the eNB then the eNB will need to indicate to the Relay prior to subframe n−4 (e.g. n−5 or a prior grant or pre-negotiation, or on pre-negotiated time/frequency location) whether it will receive a grant on subframe n−4 to transmit to the eNB on subframe n. Again this issue can be negotiated on a semi-static or dynamic basis between the relay and macro-eNB.

Advantages of the inhibit grant are as follows: 1) Minimum change to Rel-8 specification—reuse existing PDCCH (DCI) format, no impact on #blind decodes no performance impact on Rel-8, no impact on measurements, no increase of higher-layer signaling, 2) The relay may be able to dynamically pre-empty UE2 uplink transmissions—more flexibility from the macro-eNB and relay.—For e.g., if all 8 UL HARQ processes of UE2 are active, each process could be pre-emptied once per eight relay→macro eNB transmission opportunities, support asymmetric inhibition on the UL (→more improvement UL capacity), 3) Full Flexibility for Rel-10 UE2→Relay design as the relay can dynamically pre-empty UE2 uplink transmissions—For a Rel-10 device, if there are pre-emptied uplink A/N transmissions, these can be deferred by one or more subframes (can use multi-bit A/N or bundling).

The inhibition approach can be generalized based on the number of bits available in the grant—for example for scheduling compact UL grants, including but not limited to a periodic CQI-only grants and other uplink control information. Similar grant-based inhibition can be defined for Relay→Rel-10 UE2 link.

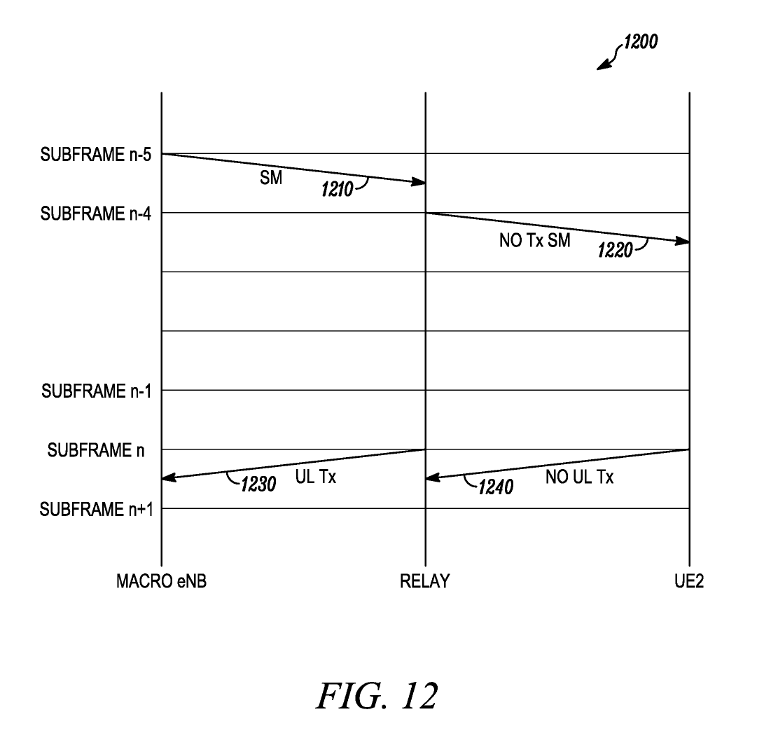

It is noted that although the primary discussion concentrated on the relay to UE2 transmission and signaling thereof, the same concepts can be applied to defer the relay to macro eNB transmissions based on the traffic load, scheduling cooperation between macro eNB and relay, etc. FIG. 12 shows a simplified timing diagram wherein the macro-eNB sends a grant 1210 to relay to enable relay to macro-eNB uplink transmission 1230. At the same time, the relay sends the inhibit grant or “No transmission” SM 1220 to disable UE2 to relay transmission 1240.

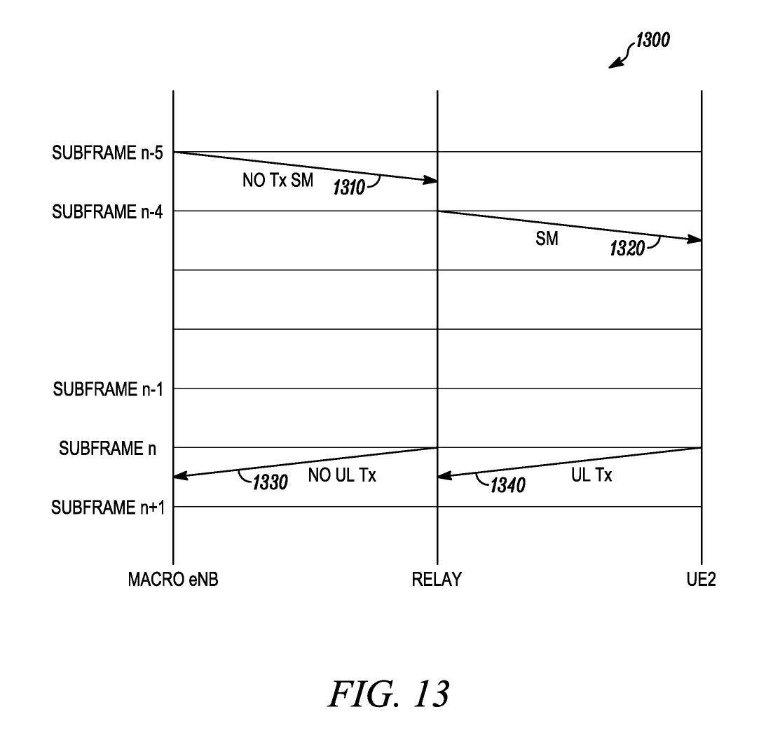

FIG. 13 shows a simplified timing diagram wherein the macro-eNB sends the inhibit grant or “No transmission” SM to disable relay to macro-eNB uplink transmission 1330. At the same time, the relay sends a grant 1320 to the UE to enable UE to relay uplink transmission 1340.

Recently, a new Rel-8 feature of introducing “blank” subframes was proposed wherein higher layer signaling on SIB was proposed to additionally introduce a “blank” subframe in addition to the MBSFN and normal subframe characterization of subframes in a Radio Frame. The supposed motivation for this “blank” is to enable relays to efficiently support legacy Rel-8 UEs. With blank subframes, Rel-8 UEs will not expect RS or PDCCH from the relay on the “blank” subframes and hence allow the relay to listen to eNB in these subframes. A blank subframe may be characterized as a subframe that for example does not contain Reference Symbols (RS). Another possible definition is that a blank subframe is one for which the UE cannot make assumptions about the presence or absence of RS. Note that there are other definitions possible for blank subframe based on the presence or absence of certain control information.

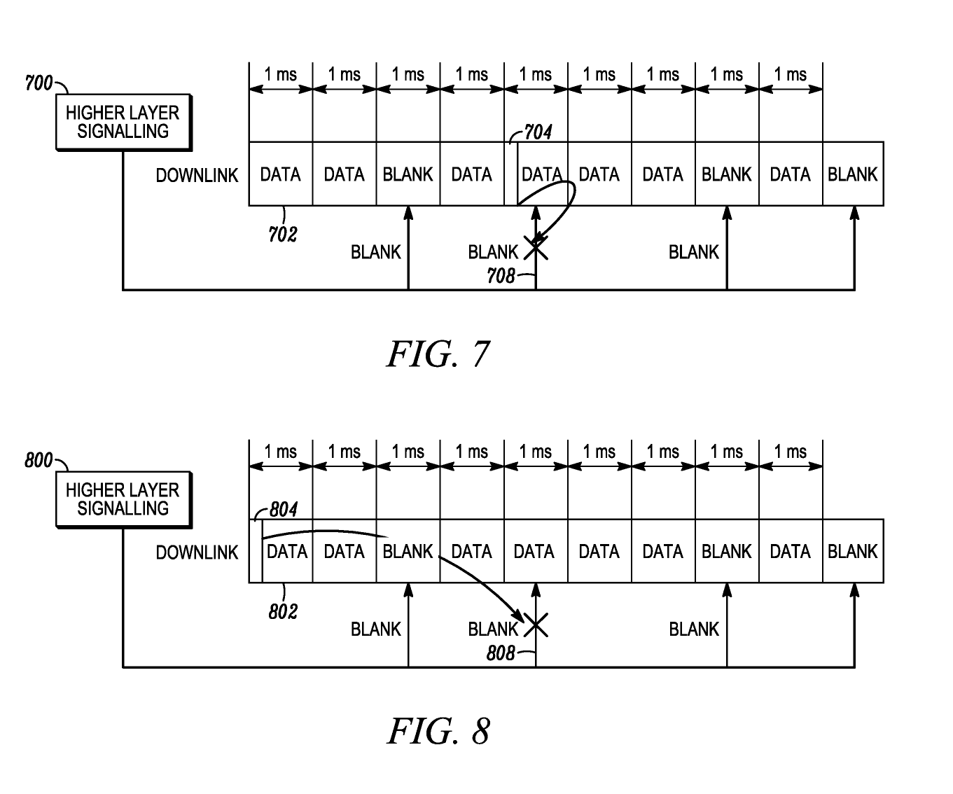

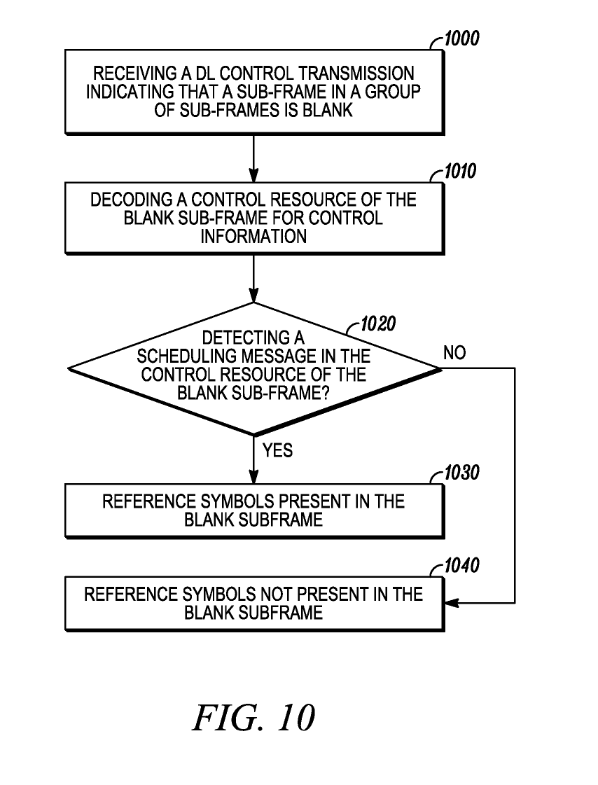

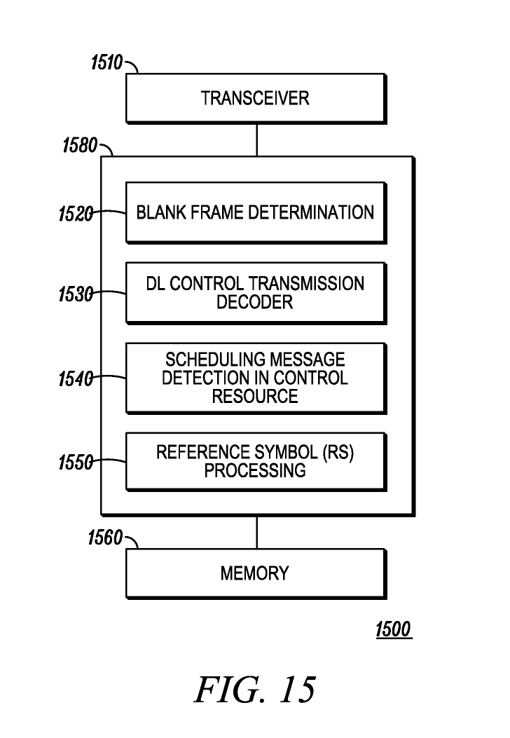

If indeed, the “blank” subframe concept is considered for Rel-8, the there is a need to dynamically “reclaim” blank subframes to transmit data and override the higher layer signaling. Since the blank subframe is signaled by higher layers, there is a need for a mechanism to override the blank subframe whenever the eNB has no data to transmit to (or receive from) the relay and therefore, the relay should be allowed to occasionally override the “blank” to transmit to (and receive from) the UE2. That is, a Rel-8 UE2 will blindly decode the PDCCH in all subframes (unicast, MBSFN or blank) and whenever it finds a grant (DL or UL) in a blank subframe, UE2 knows the relay has overridden higher-layer commands and that the subframe is not a blank and is indeed a unicast subframe (or MBSFN, for example). This requires communication between eNB and RN well in advance, but gives more flexibility. FIG. 7 shows an illustration wherein via higher layer signaling 700 the UE receives a DL control transmission indicating that a sub-frame in a group of sub-frames is blank. The UE decodes a control resource of the blank sub-frame for control information 704; and the UE detecting a scheduling message in the control resource of the blank sub-frame. If the UE detects a scheduling message in the control resource of the blank sub-frame, then the UE can assume that the higher layer signaling is overridden and the blank subframe is not blanked 708. FIG. 10 shows a flowchart. FIG. 15 shows a possible implementation with a memory 1560, controller 1580 coupled to the transceiver 1510, the controller configured to make a blank frame determination 1520, a DL control transmission decoder 1530 to decode a control resource of a blank sub-frame in a group of sub-frames for control information after receiving a DL control transmission indicating that the sub-frame is blank, the controller configured to detect a scheduling message in the control resource of the blank sub-frame and a Reference Symbol Processing.

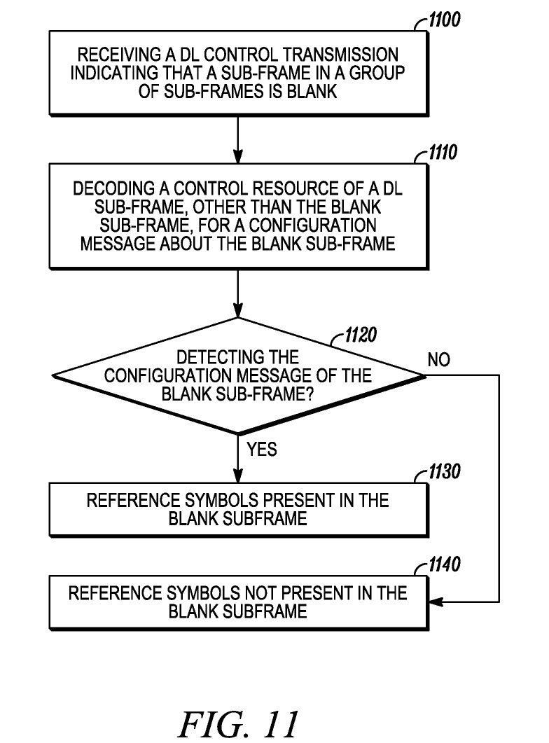

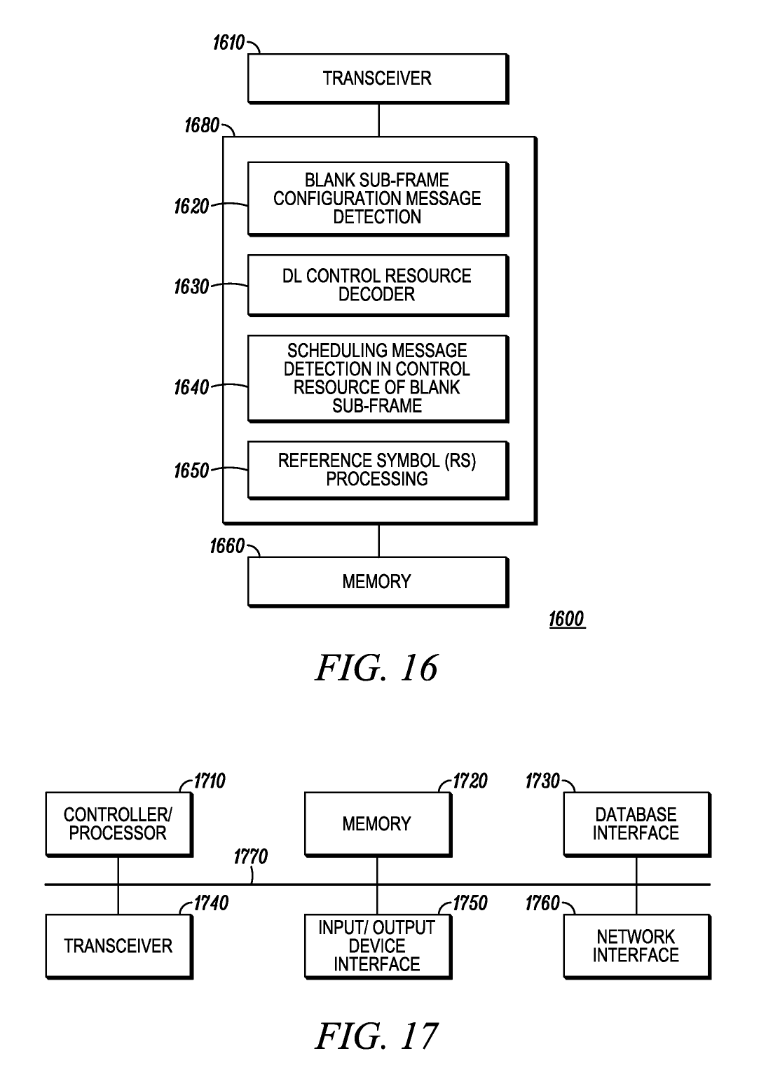

FIG. 8 shows an illustration wherein via higher layer signaling 800 the UE receives a DL control transmission indicating that a sub-frame in a group of sub-frames is blank. The UE decodes a control resource of a sub-frame other than blank subframe for control information 804; and the UE detects a scheduling message in the control resource of the blank sub-frame. If the UE detects a scheduling message in the control resource of the blank sub-frame, then the UE can assume that the higher layer signaling is overridden and the blank subframe is not blanked 808. FIG. 11 shows a flowchart. FIG. 16 shows a possible implementation with a memory 1660, controller 1680 coupled to the transceiver 1610, the controller configured to detect a blank sub-frame configuration message detection 1620, a DL control resource decoder 1630, a scheduling message detection in control resource of blank sub-frame 1640, the controller configured to detect a scheduling message in the control resource of the blank sub-frame 1640 and a Reference Symbol Processing 1650.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

We is claimed is:

1. A wireless communication entity, comprising:
a transceiver;
a controller coupled to the transceiver, the controller configured to cause the transceiver to transmit in an UL control resource in a group of sub-frames configured according to a predetermined schedule,
the controller configured to detect a indicator message in a downlink control transmission, allocated to the wireless communication entity;
the controller configured to temporarily modify the transmission in the UL control resource based on the indicator message contrary to the predetermined schedule.

2. The entity of claim 1, the controller configured to temporarily modify the transmission by not transmitting in the UL control resource in at least one sub-frame configured according to a predetermined schedule.

3. The entity of claim 1, the controller configured to temporarily modify the transmission by not transmitting in at least one UL sub-frame configured according to a predetermined schedule.

4. The entity of claim 1, the controller configured to detect the indicator message as a scheduling grant.

5. The entity of claim 1, the DL control transmission is a broadcast control transmission.

6. A method in a wireless communication entity that communicates in a wireless communication network, comprising:
transmitting in an UL control resource in a group of sub-frames configured according to a predetermined schedule;
receiving a DL control transmission;
detecting a indicator message allocated to the wireless communication entity, the indicator message is in the DL control transmission;
temporarily modifying the transmission on the UL control resource based on the indicator message contrary to the predetermined schedule.

7. The method of claim 6, temporarily modifying the transmission includes not transmitting in the UL control resource in at least one sub-frame configured according to a predetermined schedule.

8. The method of claim 6, where the indicator message is a scheduling grant.

9. A wireless communication entity comprising:
a transceiver;
a controller coupled to the transceiver,
the controller configured to decode a control resource of a blank sub-frame in a group of sub-frames for control information after receiving a DL control transmission indicating that the sub-frame is blank,
the controller configured to detect a scheduling message in the control resource of the blank sub-frame.

10. The entity of claim 9, the controller configured not to rely on the blank sub-frame for the presence of reference symbols in the absence of a scheduling message.

11. The entity of claim 9, the controller configured to use blind detection to detect the scheduling message.

12. A method in a wireless communication entity that communicates in a wireless communication network, comprising:
transmitting in an UL subframe in a group of sub-frames configured according to a predetermined schedule;
receiving a DL control transmission;
detecting a scheduling grant allocated to all wireless communication entities, the scheduling message is in the DL control transmission;
disabling all transmissions on the UL subframe based on the scheduling message contrary to the predetermined schedule.

13. The method of claim 11, detecting the scheduling message using a CRC scrambling mask.

14. The method of claim 11, detecting the scheduling message using scheduling message payload scrambling.

15. The method of claim 11, the scheduling message is determined based upon a specific field that constitutes the scheduling message.
